(19) United States
(12) Patent Application Publication
(10) Pub. No.: US 2009/0097291 A1
(43) Pub. Date: Apr. 16, 2009

(54) Universal power supply for a laptop

(76) Inventor: Ronald M. Bormann, McAllen, TX (US)

Correspondence Address: JOHN F. BRYAN, 8291 LAKESIDE DRIVE, ENGLEWOOD, FL, 34224, US

(21) Appl. No.: 12/316,073

(22) Filed: Dec. 9, 2008

Related U.S. Application Data
(63) Continuation-in-part of application No. 11/879,615, filed on Aug. 16, 2007.

(51) Int. Cl. H02M 7/06

(52) U.S. Cl. 363/126

(57) ABSTRACT

A highly efficient DC power supply for laptop computers and the like is converted directly off-line from an A.C. or DC voltage source to have a plurality of output voltages closely regulated according to the computer requirements and includes a DC voltage source for operating integrated circuits that is independent of input or output voltage. The line supply, rectified if necessary, is connected to a transformer input and switched “off” and “on” in a pulse width modulated mode at a frequency rate above 1000 Hz and the transformer outputs are filtered through a “buck” stage to permit voltage regulation by pulse width modulation from a very low percentage, which may approach zero, to as much as ninety percent “on-time”, without core saturation.

This is a continuation-in-part application to non-provisional utility patent application no. 111879,615, filed Aug. 16, 2007.

### TECHNICAL FIELD

The present invention relates generally to the field of DC power supplies and more particularly, to such power supplies as are adapted to provide accurate regulate of D.C voltage input for laptop computers and the like, over a broad range of AC input voltage.

### BACKGROUND

Laptop computers have become extremely popular, even replacing desktop units for many, especially those who must travel frequently. The downside of laptop use is that every laptop computer is ultimately dependent upon a power converting line cord for battery recharging. Battery power may suffice for a day trip or conference but the line cord must almost always be on hand for re-charging. While laptop computers are light and thin, fitting neatly into a brief case, the power converting line cord becomes an awkward, inconvenient lump.

Except for weight and heat rejection, a solution to this problem would be to provide conversion circuitry as an integral part of the computer. However, the added weight is undesirable and, because laptop components are so densely packaged, internal cooling is a primary design concern, making an additional heat source unacceptable. If such were available, a light weight, compact and highly efficient internal voltage converter would be ideal for laptop computer usage, but no prior art DC switching power supplies can operate efficiently off-line to provide the required voltage output regulation. Another desirable characteristic for general usage is that there be less than 10% AC ripple, inasmuch as excessive ripple can diminish stability and efficiency.

There are other DC power applications, such as the operation of a thermoelectric cooling elements (TECs) and cold cathode florescent lighting (CCFL), as used in computer and flat screen TV backlighting, which can benefit greatly in performance and efficiency through the use of a closely regulated DC power supply. In some such applications, the output must be variable, in others it must be constant but always, overall power efficiency is of prime importance. There are no prior art DC switching power supplies that can operate efficiently off-line to provide a regulated output ranging from zero to maximum drive capacity, in terms of either amperage or voltage.

Direct Current (DC) switching power supplies are generally used to provide electrical power for applications requiring an essentially constant input voltage and such circuits are common in the prior art. The most basic DC supply, in which a bridge rectifier and filter capacitors change AC into pure DC output, does not contemplate any form of the efficient voltage or current regulation needed in power sensitive applications, or means of compensation for line voltage variations.

A well-known regulation technique utilizes a Pulse Width Modulator (PWM) and a Metal Oxide Semiconductor Field Effect Transistor (MOSFET). The MOSFET is a very fast voltage regulated switch, turning on and off in a matter of nanoseconds. The square wave from the PWM applies the regulating signal, so that when the MOSFET is switched “On”, current flows through it and when it is “Off”, flow is blocked. Output is varied by the relative lengths of MOSFET “On Time” and “Off Time”. At 25% “Off-Time” and 75% “On-Time”, output would be approaching maximum and at 75% “Off Time” output would be approaching minimum.

There are also semi-resonate power supplies that use frequency variation to regulate output. These are based on the fact that an inductor and capacitor balanced to resonate at a given frequency will offer almost no impedance to the flow of electricity and yet have a very sharp change in impedance when the drive frequency is shifted slightly. These units are useful for regulation over no more than a 5% to 15% range.

A first object of the present invention therefore, is to provide an AC rectifying, DC power supply capable of output voltage regulation ranging from zero volts to its maximum drive capacity. A second object is for this DC power supply to have greater overall efficiency than prior art power supplies for similar uses. A fifth object is for this DC power supply to have less than 10% AC ripple. A sixth object is that this DC power supply be capable of operating directly off either AC or DC line at any voltage from 80V to 280V and providing a plurality of D.C. voltage outputs as required by a laptop computer. A final object is that this power supply be inexpensive, so as to be commercially viable for laptop computers and other applications, such as, but not limited to, cold cathode florescent lighting (CCFL) as used in computer and flat screen TV back-lighting.

### SUMMARY OF THE INVENTION

The present invention relates to or employs some steps and apparatus well known in the electrical arts, thus, not the subject of detailed discussion herein. This invention addresses the aforesaid objectives in a preferred embodiment employing technology understood by those skilled in the art.

The first section of the present invention is an A.C. to DC conversion stage, which should also pass electric power that is already DC. If a power factor correction should be required, it can be applied in this section by prior art means.

The next section is an “always on” low voltage power supply that provides operating voltage for all other portions of the circuit. Inasmuch as 60 Hz line transformers are comparatively large and energy wasteful, a small, self-starting switching power supply is provided for this stage. This auxiliary power supply starts up by charging a capacitor through a high value input resistor until the under-voltage lockout of the controlling IC is reached. The supply begins to run from this stored charge at a high frequency, until rectified power from a “bias” winding on this supply's output transformer takes over at a level slightly higher than lockout voltage. This effectively removes the input resistor from the circuit so as to eliminate its consequential heat rejection.

The third stage of this design is a pulse width modulator (PWM) that is capable of providing pulses from 0 to 90% duty cycle (on-time to off-time). In most switching power supplies this would be limited to 50% duty cycle to prevent pushing the inductor beyond saturation. This design, being of a feed forward (transformer based) topology and using the output “buck” stage simply for filtering, avoids this problem. This capability of large variation in duty cycle gives a large range of control over the output Running the feed forward/buck topology at a high frequency, which may be in the MHz range, eliminates the need for a large 60 Hz transformer.

The next stage of this design is a MOSFET driver circuit. This device translates the signal level drive from the PWM to a higher power level capable of driving the main switching device (MOSFET in this example).

The switching device regulates current flow through the main transformer with a duty cycle that has been set by the PWM. The ratio from primary to secondary of this transformer is such that with the lowest voltage expected being present at the line input, and the PWM duty cycle at 90%, the voltage at the output is the maximum that will be expected from a particular application of this supply. When several different output voltages are required, as for a laptop computer power supply, the transformer secondary comprises several windings, each of the appropriate ratio to the others and to the primary.

The diode, inductance and capacitance, “buck” stage of this supply is used to rectify and filter the power coming from the transformer secondary. The main reason for using this stage is that, during the off period at very low percentage duty cycle, when there is no power coming from the transformer, the inductor will be providing voltage to the output due to the collapsing magnetic field applied through the diode. Careful selection of values for the inductance and capacitance will serve to limit ripple and fall-off of output voltage under load. When several secondary windings are involved, the output of each is rectified and filtered by its own buck stage.

Feedback to regulate the power supply can be derived by many different means, from voltage sensors, current sensors, or by monitoring the process that is being driven by this supply and developing a feedback signal from this information.

### BRIEF DESCRIPTION OF THE DRAWINGS

The accompanying drawings are incorporated into the specification to assist in explaining the present invention. The drawings illustrate a preferred example of how the invention can be made and used and are not to be construed as limiting the invention to only those examples illustrated and described. The various advantages and features of the present invention will be apparent from a consideration of the drawings in which:

FIG. 1 is a schematic diagram shown as FIG. 2 of previously filed application Ser. No. 11/879,615 depicting a power supply circuit of the present invention used for a usable circuit for providing rectified high and low DC voltage sources for the present invention;

FIG. 2 is a schematic diagram of a usable circuit for a power supply according the present invention;

FIG. 3 is a schematic diagram showing a preferred embodiment of circuit of the present invention for providing rectified high and low DC voltage;

FIG. 4 is a schematic diagram of a preferred embodiment of the variable DC power supply of the present inventions;

FIG. 5 is a schematic diagram of a regulating circuit for the current output of the variably regulated DC power supply of FIG. 4;

FIG. 6 is a schematic diagram of a regulating circuit for the voltage output of the variably regulated DC power supply of FIG. 4; and

FIG. 7 is a schematic diagram of a preferred embodiment of the variable DC power supply of the present inventions as adapted to provide a power supply for laptop computers and the like.

### DETAILED DESCRIPTION OF THE DRAWINGS

The present invention is described in the following by referring to drawings of examples of how the invention can be made and used. In these drawings, reference characters are used throughout the views to indicate corresponding parts. The embodiment shown and described herein is exemplary. Many details are well known in the art, and as such may be neither shown nor described.

As shown in FIG. 1, a schematic diagram of a possible circuit 100 for providing rectified high and low DC, line voltage (120VAC in the U.S.) is rectified and filtered by rectifying bridge 18 and capacitor 22 to provide the input voltage supply (169VDC in the U.S.) at connection 130 for either main power supply 200 or 400. The low voltage signal supply capacitor 24 is chosen to have AG impedance such that all but 8.5VAC will drop thereacross. This AC impedance acts as a loss-free resistance, wherein the voltage drop does not convert to heat. This 8.5VAC is rectified, filtered and regulated to supply 12VDC at connection 120 by rectifying bridge 26, filter capacitor 28 and zener diode 30. Circuit 100 is problematic and hence, not preferred, inasmuch as there must be two separate grounds, totally isolated from one another.

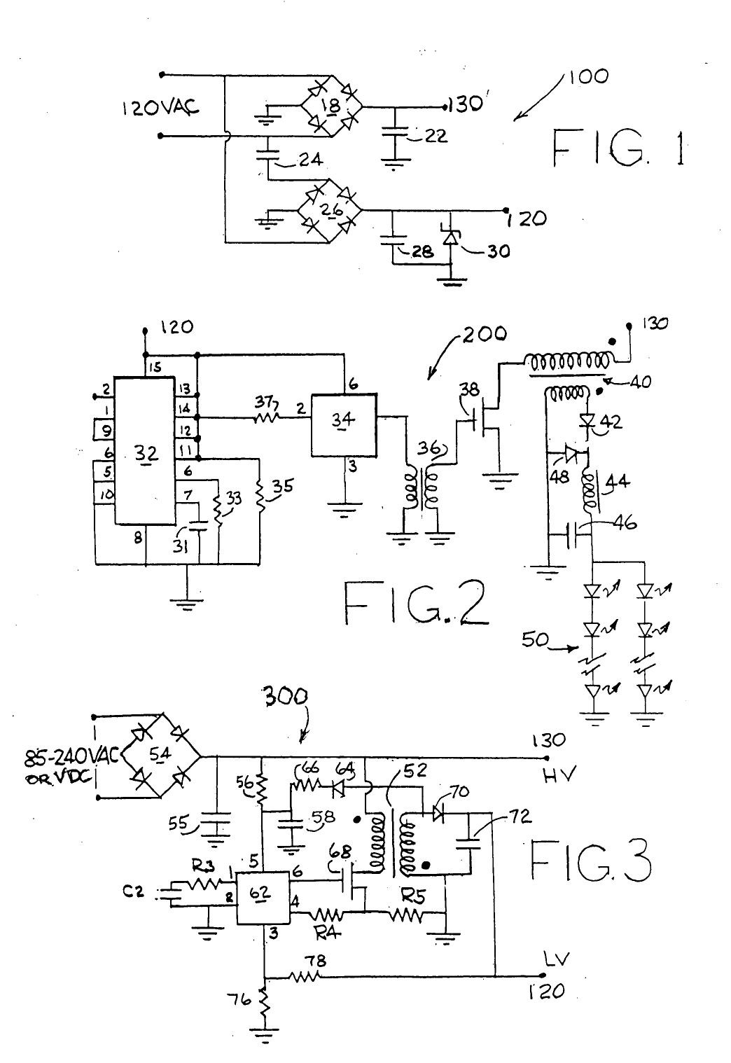

In FIG. 2, is shown a schematic diagram of a possible circuit 200 for the main power supply, operating on the 12VDC supplied at connection 120. Here, pulse width modulator (PWM) 32 in this case, shown with numbered pin connections as a SG3524 integrated circuit (IC), with 0.001 mmf capacitor 31 to pin 7, 2,000 ohm resistor 33 to pin 6. 140 ohm resistor 35 and 680 ohm resistor 37 are connected to low voltage supply connection 120. In this case, PWM 32 runs at 425 KHz, to provide a pulse width modulated signal, which may be varied through an “On time” to “Off time” ratio of from +0% and 90% for purposes of output regulation. This signal is input to driver circuit 34, in this case, shown with numbered pin connections as a TC427 IC, where it is translated to a higher level for driving main switching device 38, a MOFSET. Driver circuit 34 drives pulse transformer 36 which, with a 1/1 turns ratio, couples this signal to the gate terminal of switching device 38, while isolating the low voltage supply from the 169VDC supply. Thus, switching device 38 regulates power flowing from the high voltage provided at connection 130, through the primary of transformer 40, and in step with the PWM signal originally developed by PWM 32 in typical feed forward converter topology. The secondary of transformer 40 isolates the output drive from the line and is wound with fewer turns than the primary, giving a step-down of voltage. Diode 42 acts as a steering diode, to prevent any reverse path back through the secondary of transformer 40. During the “on-time” the PWM drive charges inductor 44, which is filtered by capacitor 46. During the “off-time” of the PWM drive, the magnetic field developed in inductance 44 will cause electrical flow back through diode 48, again being filtered by capacitor 46, in typical buck configuration.

The load 50 in this instance is provided by LEDs in paralleled strings 51 across capacitor 46, and feedback is used to regulate the current flowing through the LEDs. Since all power is at much higher frequency than 60 Hz line frequency, the magnetics (transformer 40 and inductor 44) are physically small. It should be noted that paralleled LED strings 51 are vulnerable to any resistive imbalance and hence not preferred. Inasmuch as resistance is not used to run the low voltage supply, and as long as the components are appropriately rated, this circuit will work on both USA and European line voltages.

FIG. 3 shows a preferred embodiment for an independent low voltage D.C supply 300, for operating power for all ICs in main supplies 200 or 400. Note the polarity dots on high frequency transformer 52, indicating that this circuit is configured as a flyback supply. While other operating modes might work, the flyback mode is more simple and smaller than other configurations, so as to lend itself best to miniaturization. Power, with filtering by capacitor 55, flows from rectifying bridge 54 to the high voltage buss connection 130, and is tapped through starting resistor 56, to charge capacitor 58 over a short period of time. Once the voltage on capacitor 58 exceeds start-up lockout voltage, pulse width modulator 62 (in this case, an LTC3803 device) begins to drive auxiliary transformer 52. Capacitor 58 is sized large enough to support several cycles of operation. Once the circuit is running in a stable mode, capacitor 58 is kept charged by diode 64 and resistor 66, effectively taking resistor 56 out of the circuit, so as to provide virtually loss free power for integrated circuit operation. Most significantly, independent supply 300 starts off-line and, with PWM LTC3803 device 62, MOFSET 68 switches at an elevated frequency, chosen to reduce the physical size of components.

This preferred embodiment operates at 25 KHz, so as to use readily available components, but any switching frequency, from 1,000 Hz to 4 MHz, according to the designer's choice may be used, depending upon overall size limitations and interference considerations. At the higher frequencies, the time involved in switching becomes increasingly more significant and efficiency may begin to drop, but the higher the frequency, the smaller the magnetic and capacitive components. The output voltage can be regulated at any appropriate value for a given application, usually 8.5 VDC, but generally any required value up to 24 VDC or more.

Diode 70 and capacitor 72 rectify and filter the output of transformer 52 to deliver low voltage supply at low voltage connection 120. This operating voltage is maintained regardless of the output of main supply 200 or 400. Furthermore, voltage feedback developed at pin 3 of the LTC3803 device 62 by resistors 76 and 78 can regulate auxiliary supply 300, so as to maintain an independent, fixed operating voltage as line input varies across a range of 85-265V (AC or DC) and as the output of the main supply ranges from zero to its maximum.

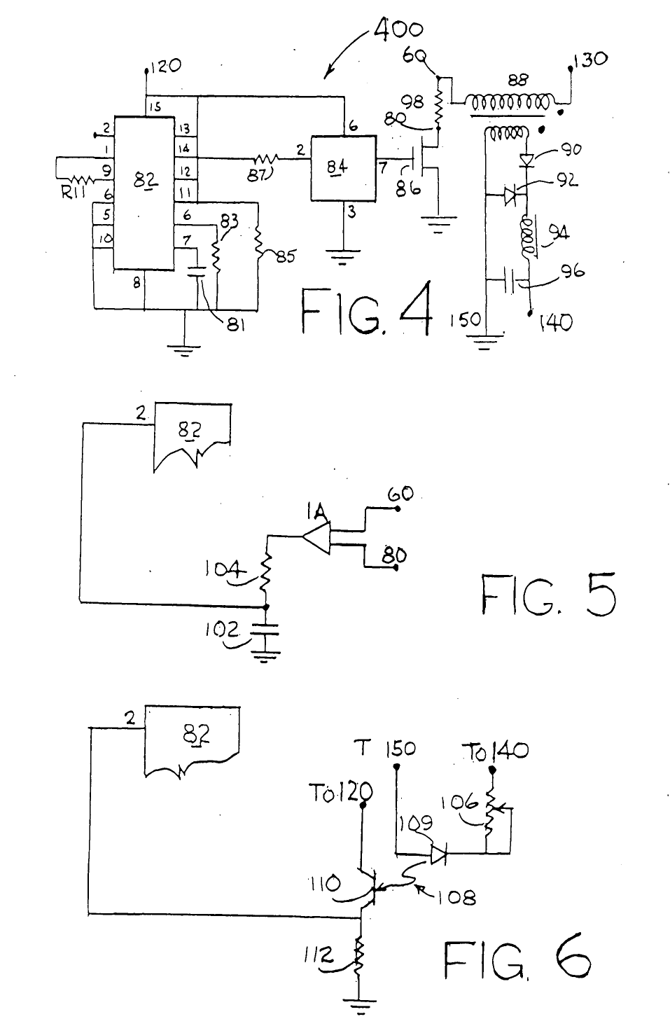

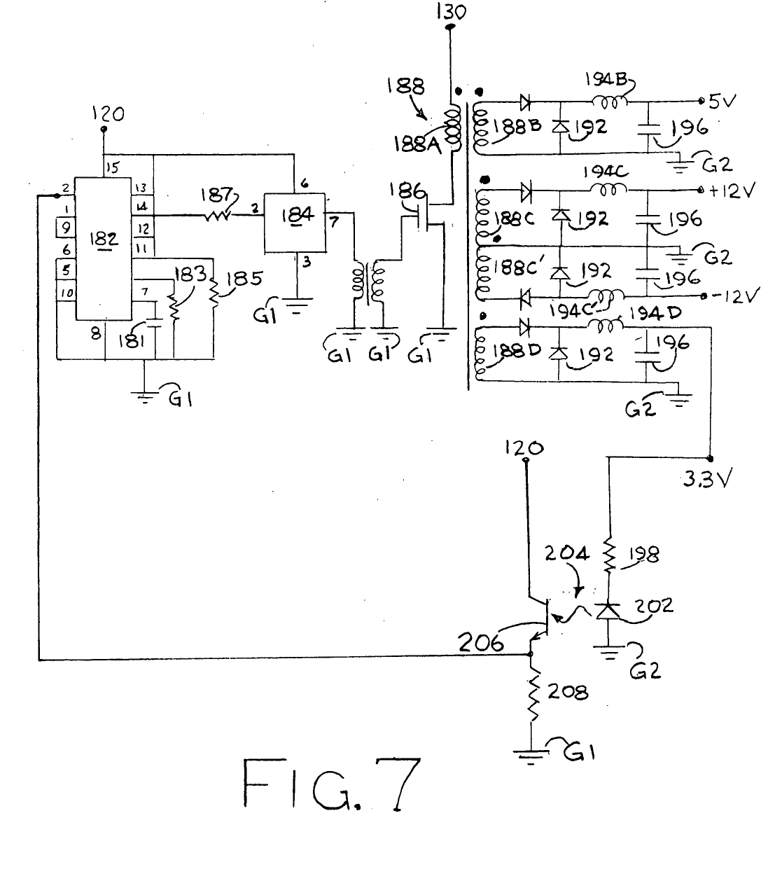

FIG. 4 shows a schematic diagram of main variable DC power supply 400. Operating (low) voltage is supplied to the ICs at connection 120 and power input (high) voltage is supplied at connection 130. Pulse width modulating device 82, is configured to provide a square wave drive signal of from less than 10% “on time” to over 90% “on time” (in this example, an SG3524, running at 425 KHz). Operating at frequency rates above 1,000 Hz is preferred, inasmuch as, higher frequencies, up to a probable upper limit of 4 MHz, allow the use of smaller circuit components. This signal is fed to a switching circuit, in this example, comprising driving device 84, shown with the numbered pin connections of a TC 427, and with MOFSET switching device 86. Switching device 86 regulates current flow through transformer 88, and thus the amount of power transferred to the output circuitry and the load connections 140 and 150 for an unshown power-dissipating load. Connections 60 and 80, across resistor 98 provide for feedback regulation according to FIG. 5.

The turns ratio from primary to secondary is set to provide the maximum output voltage (or current) expected at the load with the input voltage to rectifying bridge 54 at its minimum, and the duty cycle (on time/off time) at its maximum of around 90%. The output of main supply 400 can be regulated by varying the “On-Off” duty cycle across its range of approximately 10% “On” to 90% “On”. Diodes 90 and 92, together with inductor 94 and capacitor 96, rectify and filter the output of transformer 88. Diodes 90 and 92, together with inductance 94 and capacitor 96, are in a standard buck configuration, but if transformer 88 were not used, inductance 94 would saturate above a 50% duty cycle and at 60% would probably overload MOSFET 86 to failure.

In a conventional “buck” circuit, the inductor functions to reduce the switched DC high voltage down to the expected output voltage. As long as the magnetic field can continue to grow as current is applied to the inductor, the expanding magnetic field generates an opposing current that acts to limit current flow. This opposing current, in combination with the impedance or resistance of the load determines the output voltage. When the core has become fully magnetized, the inductor is saturated, and expansion of the magnetic field stops. Without a moving magnetic field, there is no generation of an opposing current, and the inductor acts simply as a piece of wire across the load. Without this power absorbing magnetic field growth, current overload will explosively blow the MOSFET if not the load. Conventionally, when the DC high voltage is switched “Off”, the magnetic field collapses so as to generate a continuing flow of current, through a diode to a capacitor and the load. It is important that the DC high voltage remain “Off” for a long enough time for all of the magnetic field to be converted to electrical current, inasmuch as any remaining field will accumulate from pulse to pulse, to the point of saturation.

In the power supply of the present invention, the “buck” section is active until the inductor is saturated, and from that point on, the total circuit behaves as a transformer based feed forward. Without the “buck” circuit components, the lower voltage portion of the output range would be subject to “load sag” ripple and it would be very difficult to get down to zero volts output.

If a boost/buck circuit were used, instead of a transformer followed by a buck stage, the overall supply would be more complex, the duty cycle timing would be very critical and, maximum power output would be reduced. Also, inasmuch as the inductor would act as both primary and secondary, the efficiency would be reduced.

FIG. 5 illustrates an example of feedback regulation for the current output of main supply 400, for applications requiring current regulation, such as an LED drive. Since all output power must pass through the primary of transformer 88, sensing the voltage drop across low value resistor 98 at points 60 and 80 gives a regulate voltage proportional to the current output of transformer 88. Inasmuch as sensing is all on the primary side of transformer 88, current output is fully isolated and independent of variations in line voltage.

Instrument Amplifier IA amplifies the small regulating voltage and charges capacitor 102 through resistor 104. The set point can be adjusted by varying the gain of IA or by varying resistor 104. Thus, this voltage provides a feedback signal to pin 2 of the SG3524 pulse width modulator 82, decreasing the pulse width modulation “on-time/off-time” ratio, at the operating frequency rate, as the feedback signal increases above the set-point value, and increasing the pulse width modulation “on-time/off-time” ratio, at the frequency rate, as the voltage to resistor 112 decreases below the set-point equivalent value equivalent.

FIG. 6 shows a means of regulating voltage output. Variable resistance 106 sets the amount of current allowed to flow through the LED portion 109 of optocoupler 108 and acts to provide an adjustable set-point. The brightness of LED portion 109 regulates the resistance of optocoupler transistor portion 110. As the brightness of LED 109 increases, the resistance of transistor 110 also increases and the voltage to grounded resistor 112 decreases. This voltage provides regulating feedback to pin 2 of the SG3524 pulse width modulator 82, decreasing the pulse width modulation “on-time/off-time” ratio, at the operating frequency, as the voltage to resistor 112 rises above the set-point equivalent value. In a like manner, if output voltage falls below the set-point, the brightness of LED 109 decreases; the resistance of diode 110 decreases; and the voltage to resistor 112 and pin 2 increases. This causes a decrease in the pulse width modulation “On time” to “Off time” ratio, at the operating frequency, so as to bring output voltage back to the set-point. Since the connection between the primary side of transformer 88 and the transformer output is optical, not electrical, output voltage is isolated from the line.

FIG. 7 shows a schematic diagram of main variable DC power supply 500. Operating (low) voltage is supplied to the ICs by FIG. 3 circuit 300 at connection 120 and power input (high) voltage is supplied at connection 130. Pulse width modulating device 182, is configured to provide a square wave drive signal of from less than 10% “on time” to over 90% “on time” (in this example, an SG3524, running at 425 KHz). Operating at frequency rates above 1,000 Hz is preferred, inasmuch as, higher frequencies, up to a probable upper limit of 4 MHz, allow the use of smaller circuit components. This signal is fed to a switching circuit, in this example, the switching circuit comprises driving device 184, shown with the numbered pin connections of a TC 427, and with switching device 186 being a MOFSET. Switching device 186 regulates power input to primary winding 188A of transformer 188 and transmitted to a plurality of secondary windings 188 B-D and circuitry for the designated 5V, +12V and 3.3V connection voltages. With the input voltage to rectifying bridge 54 (FIG. 3) at its minimum, and the duty cycle (on time/off time) at its maximum of around 90%, primary 188A to secondary 188 B-D turns ratios are as required to provide the designated outputs. The outputs of main supply 500 can be regulated by varying the “On-Off” duty cycle across its range of approximately 10% “On” to 90% “On”. Diodes 190 and 192, together with inductors 194(B-D) and capacitors 96, rectify and filter the outputs of transformer 188. Diodes 90 and 92, together with inductances 94(B-D) and capacitors 96, are in a standard buck configuration, but if transformer 188 were not used, inductances 94(B-D) would saturate at a 60% duty cycle and probably overload MOSFET 186 to failure.

The Line voltage source, independent low voltage supply 300, and primary winding 188A are commonly grounded at ground connections G1. Secondary windings 188 B-D and associated circuits are grounded at isolated ground connections G2, separating the outputs from the power input circuitry to protect the laptop from potential interference or electrical disruption.

Feedback regulation of the 3V, +12V and 5V outputs is controlled as shown in FIG. 6, from the output considered most critical, which may be 3.3V, as shown here. Resistance 198 sets the amount of current allowed to flow through the LED portion 202 of optocoupler 204. The brightness of LED portion 202 regulates the resistance of optocoupler transistor portion 206. As the brightness of LED 202 increases, the resistance of transistor portion 206 also increases and the voltage to grounded resistor 208 decreases. Through determination of a set-point equivalent voltage, this provides regulating feedback to pin 2 of the SG3524 pulse width modulator 182, decreasing the pulse width modulation “On time” to “Off time” ratio, at the operating frequency, as voltage to resistor 208 rises above the set-point equivalent. In a like manner, if output voltage falls, the brightness of LED 202 decreases; the resistance of transistor portion 206 decreases; and voltage to resistor 208 and pin 2 increases. Thus, optocoupler 204 facilitates isolation of G2 from G1. If the benefits of isolated grounding are forsaken, the output voltages may also be regulated in the manner shown by, and described for FIGS. 4 and 5 or other prior art means.

The embodiments shown and described above are exemplary. It is not claimed that all of the details, parts, elements, or steps described and shown were invented herein. Even though many characteristics and advantages of the present inventions have been described in the drawings and accompanying text, the description is illustrative only. Changes may be made in the detail, especially in matters of selection and arrangement of parts within the scope and principles of the inventions. The specific examples above do not point out what an infringement of this patent would be, but do provide at least one explanation of how to use and make the inventions. The limits of the inventions and bounds of the patent protection are measured and defined by the following claims.

I claim:

1. A method for converting a line voltage source to provide a power supply with a plurality of D.C. voltage outputs for powering a laptop computer, comprising the steps of:
rectifying the line voltage, if A.C., to provide a D.C. power supply voltage and an independent low voltage D.C. source for operating integrated circuit switching and regulating components;
connecting the DC power supply voltage source to a first transformer primary winding having a given number of turns;
providing a like plurality of first transformer secondary windings with turns ratios proportionate to the designated D.C. outputs;
switching the DC voltage connected to the first transformer primary winding “off” and “on”, in a selected pulse width modulated mode of from 0% to more than 60% “On time”, at a frequency above 1,000 Hz
rectifying the secondary winding outputs and filtering the outputs through a “buck” stage so as to permit pulse width regulation in excess of 60% “On time”; and
regulating the secondary winding voltages at predetermined levels by varying the pulse width modulated mode “On time” percentage according to a feedback signal from a secondary winding output.

2. The method of claim 1 wherein providing the independent low voltage DC source comprises the steps of:
connecting a second transformer to the line voltage source;
tapping the rectified line voltage to charge a capacitor so as to provide loss free start-up low voltage for operating integrated circuits;
modulating the start-up low voltage at a frequency above 1,000 Hz to activate the second transformer; and
supplanting the start-up voltage with voltage provided by the second transformer.

3. The method of claim 1 wherein providing the independent DC low voltage source further comprises the steps of:
tapping the line voltage source to charge a capacitor so as to provide an AC low voltage source;
rectifying the AC low voltage to provide DC low voltage; and
paralleling the DC low voltage with a zener diode selected to regulate the voltage level as desired for operating integrated circuits.

4. The method of claim 1 wherein regulating first transformer output voltages further comprises the steps of:
providing a resistance voltage drop value proportional to a selected first transformer output voltage;
establishing a set-point for the resistance voltage drop equivalent to the desired output voltage;
decreasing the pulse width modulation “On time” to “off time” ratio as the voltage drop increases above the set-point equivalent value; and
increasing the pulse width modulation “On time” to “Off time” ratio as the voltage drop decreases below the set-point equivalent value.

5. The method of claim 1 wherein regulating first transformer voltage outputs further comprises the steps of:
providing a current proportional to a selected first transformer output voltage;
passing the current through the LED portion of an optocoupler so as to regulate the resistance of its transistor portion;
determining the voltage drop across the transistor portion equivalent to the desired output voltage;
sensing the voltage drop across the transistor portion;
decreasing the pulse width modulation “On time” to “Off time” ratio as the voltage drop increases above the equivalent value; and
increasing the pulse width modulation “On time” to “Off time” ratio as the voltage drop decreases below the equivalent value.

6. The method of claim 1 and further comprising the steps of:
grounding the line voltage source, the independent low voltage D.C. source and the first transformer primary winding with first ground connections;
separately grounding the first transformer secondary windings with second ground connections; and
isolating the first and second ground connections.

7. The method of claim 2 wherein regulating first transformer output voltages further comprises the steps of:
providing a resistance voltage drop value proportional to a selected first transformer output voltage;
establishing a set-point for the resistance voltage drop equivalent to the desired output voltage;
decreasing the pulse width modulation “On time” to “Off time” ratio as the voltage drop increases above the set-point equivalent value; and
increasing the pulse width modulation “On time” to “Off time” ratio as the voltage drop decreases below the set-point equivalent value.

8. The method of claim 2 wherein regulating first transformer voltage outputs further comprises the steps of:
providing a current proportional to a selected first transformer output voltage;
passing the current through the LED portion of an optocoupler so as to regulate the resistance of its transistor portion;
determining the voltage drop across the transistor portion equivalent to the desired output voltage;
sensing the voltage drop across the transistor portion;
decreasing the pulse width modulation “On time” to “Off time” ratio as the voltage drop increases above the equivalent value; and
increasing the pulse width modulation “On time” to “Off time” ratio as the voltage drop decreases below the equivalent value.

9. The method of claim 2 and further comprising the steps of:
grounding the line voltage source, the independent low voltage D.C. source and the first transformer primary winding with first ground connections;
separately grounding the first transformer secondary windings with second ground connections; and
isolating the first and second ground connections.

10. The method of claim 3 wherein regulating first transformer output voltages further comprises the steps of:
providing a resistance voltage drop value proportional to a selected first transformer output voltage;
establishing a set-point for the resistance voltage drop equivalent to the desired output voltage;
decreasing the pulse width modulation “On time” to “Off time” ratio as the voltage drop increases above the set-point equivalent value; and
increasing the pulse width modulation “On time” to “Off time” ratio as the voltage drop decreases below the set-point equivalent value.

11. The method of claim 3 wherein regulating first transformer voltage outputs further comprises the steps of:
providing a current proportional to a selected first transformer output voltage;
passing the current through the LED portion of an optocoupler so as to regulate the resistance of its transistor portion;
determining the voltage drop across the transistor portion equivalent to the desired output voltage;
sensing the voltage drop across the transistor portion;
decreasing the pulse width modulation “On time” to “Off time” ratio as the voltage drop increases above the equivalent value; and
increasing the pulse width modulation “On time” to “Off time” ratio as the voltage drop decreases below the equivalent value.

12. The method of claim 3 further comprising the steps of:
grounding the line voltage source, the independent low voltage D.C. source and the first transformer primary winding with first ground connections;
separately grounding the first transformer secondary windings with second ground connections; and
isolating the first and second ground connections.

13. A method for converting line voltage to provide an independent low voltage supply source, comprising the steps of:
rectifying and filtering A.C. line voltage if required, to provide a DC voltage source and connecting the DC voltage source to the primary winding of a transformer;
tapping the DC voltage source through a dropping resistor so as to charge a capacitor and provide a start-up low voltage for operating a pulse width modulating integrated circuit;
pulse modulating the start-up low voltage at a frequency above 1,000 Hz;
driving an on/off switching device in the transformer primary winding at that frequency, so as to drive the transformer; and
supplanting the start-up low voltage with voltage from the transformer secondary winding, so as to provide the independent low voltage supply source.

14. A method according to 13, and further comprising the steps of:
connecting the DC voltage source to the primary winding of a second transformer;
applying the independent power supply to drive pulse width modulating and switching of the DC voltage to the second transformer primary winding,
switching the DC voltage to the second transformer “Off” and “On”, in a regulated pulse width modulated mode of from 0% to more than 60% “On time”, at a fixed frequency rate above 1,000 Hz;
providing the second transformer with a plurality of secondary windings;
filtering the second transformer voltage outputs through “buck” stages so as to permit pulse width modulation in excess of 60% “On time”; and
regulating second transformer voltage output at any selected level from zero to maximum by varying the “On time” percentage from 0% to above 60% at the fixed frequency rate.

15. The method of claim 13 wherein regulating second transformer voltage outputs further comprises the steps of:
providing a voltage drop across a resistor in the second transformer input circuit;
determining the set-point voltage drop value across the resistor equivalent to the desired second transformer output current;
decreasing the pulse width modulation “On time” to “Off time” ratio for the second transformer as the voltage drop increases above the set-point equivalent value; and
increasing the pulse width modulation “On time” to “Off time” ratio for the second transformer as the voltage drop decreases below the set-point equivalent value.

16. The method of claim 13 wherein regulating second transformer power output to the power dissipating load further comprises the steps of:
providing a current proportional to one of the output voltages;
passing the current through the LED portion of an optocoupler so as to regulate the resistance of its transistor portion;
determining the set-point voltage drop across the transistor portion equivalent to the desired output voltage;
sensing the voltage drop across the transistor portion;
decreasing the pulse width modulation “On time” to “Off time” ratio for the second transformer as the voltage drop increases above the set-point equivalent value; and
increasing the pulse width modulation “On time” to “Off time” ratio for the second transformer as the voltage drop decreases below the set-point equivalent value.
